(19) United States
(12) Patent Application Publication
(10) Pub. No.: US 2008/0236413 A1
(43) Pub. Date: Oct. 2, 2008

(54) Media carrier

(76) Inventors: Jeffrey G. Castleberry, Vancouver, WA (US); Brian Hemmerlin, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/731,078

(22) Filed: Mar. 30, 2007

(51) Int. Cl. B41F 17/00

(52) U.S. Cl. 101/37; 101/474; 101/485

(57) ABSTRACT

A carrier for supporting a media in a printing device for printing thereon includes a support portion configured to support the media, a tapered portion contiguous with the support portion, and at least one tab protruding from a surface of the tapered portion and extending beyond a leading edge of the tapered portion.

### BACKGROUND

Printers have traditionally been used for printing on a variety of media, from standard paper stock to labels and articles. Among these articles are optical data storage disks (commonly referred to as compact disks or CDs). Optical data storage disks include a layer which may be read or written on by a laser of an optical drive system. Formats of optical data storage disks include, for example, compact disk (CD) media, CD-recordable (CD-R) media, CD-read only memory (CD-ROM) media, CD-rewritable (CD-RW) media, digital versatile disk or digital video disk (DVD) media, DVD-random access memory (DVD-RAM) media, and other types of rewritable optical media, such as magneto-optical (MO) disks and phase-change optical disks.

Optical data storage disks are often provided with a printable surface opposite the side from which data is recorded and retrieved. As disk-shaped media, a tray or carrier is often used to hold such disks for positioning of the disks in a printer to facilitate printing on the printable surface. Because this tray or carrier is generally thicker than standard paper stock, consideration should be given to the manner in which the tray is fed into the printer. Existing solutions for feeding such a tray or carrier into a printer have often been expensive and complex, have resulted in damage to the printer and/or the tray or carrier itself, or have resulted in stalling of the tray or carrier within the printer.

For these and other reasons, a need exists for the present invention.

### BRIEF DESCRIPTION OF THE DRAWINGS

FIG. 1 is a schematic perspective view illustrating one embodiment of a printing system.

FIG. 2 is a perspective view of one embodiment of a carrier for supporting a media in a printing device for printing on the media.

FIG. 3 is a plan view of one embodiment of the carrier of FIG. 2.

FIG. 4 is a cross-sectional view of one embodiment of the carrier of FIG. 2 from the perspective of line 4-4 of FIG. 2.

FIG. 5 is a perspective view illustrating one embodiment of inserting the carrier of FIG. 2 into one embodiment of a portion of a printing device.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

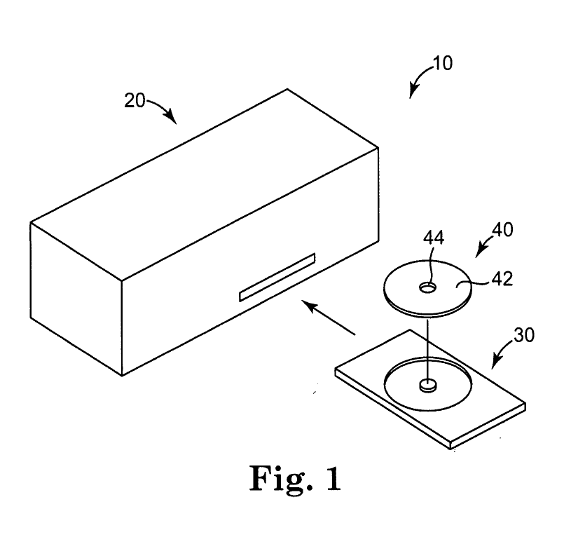

FIG. 1 schematically illustrates one embodiment of a portion of a printing system 10. Printing system 10 includes a printing device 20 and a tray or carrier 30. Printing device 20 is defined to include any device or system capable of producing or generating printed output such as, for example, an ink jet printer, a laser printer, a thermal transfer printer, or a multi-functional device providing printing, copying and/or scanning capabilities.

In one embodiment, carrier 30 supports a media 40 for printing on media 40 by printing device 20 when carrier 30 (with media 40) is inserted into or positioned in printing device 20. In one embodiment, media 40 is a circular or disk-shaped media.

In one exemplary embodiment, media 40 includes an optical data storage disk. As an optical data storage disk, media 40 may include, for example, a compact disk (CD) media, a CD-recordable (CD-R) media, a CD-read only memory (CD-ROM) media, a CD-rewriteable (CD-RW) media, a digital versatile disk or digital video disk (DVD) media, a DVD-random access memory (DVD-RAM) media, or any other type of writeable optical media, such as a magneto-optical (MO) disk or phase-change optical disk.

In one embodiment, media 40 includes a circular area 42 having a central bore or opening 44 formed therein. In one embodiment, opening 44 is sized to accommodate a drive pin or other engagement feature of an optical disk drive (not shown). In one embodiment, media 40 includes a layer which may be read or written on by a recording head.

In one embodiment, circular area 42 of media 40 provides a printable area for media 40. In one embodiment, media 40 is supported by carrier 30 such that carrier 30 and media 40 are inserted into or positioned in printing device 20, as described below, for printing on media 40 including, more specifically, circular area 42 of media 40 by printing device 20. As such, printing device 20 prints graphics or images directly on media 40.

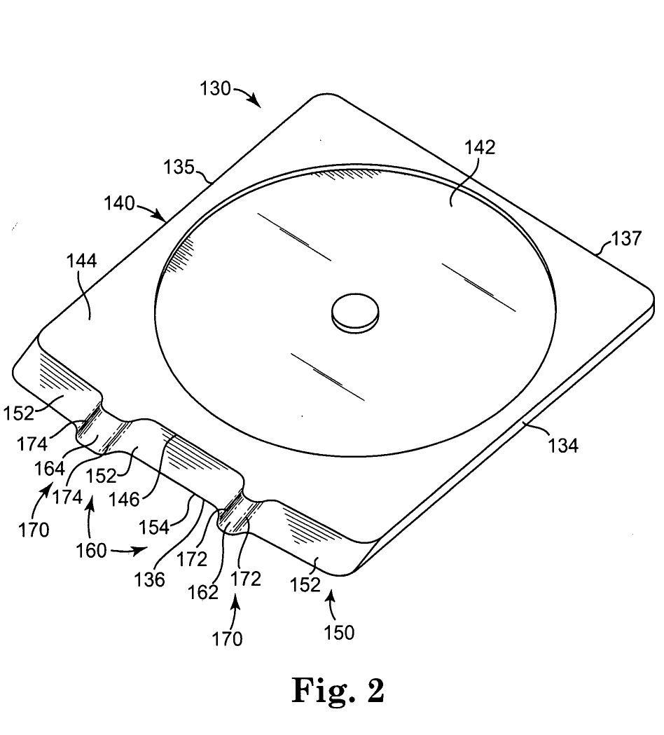

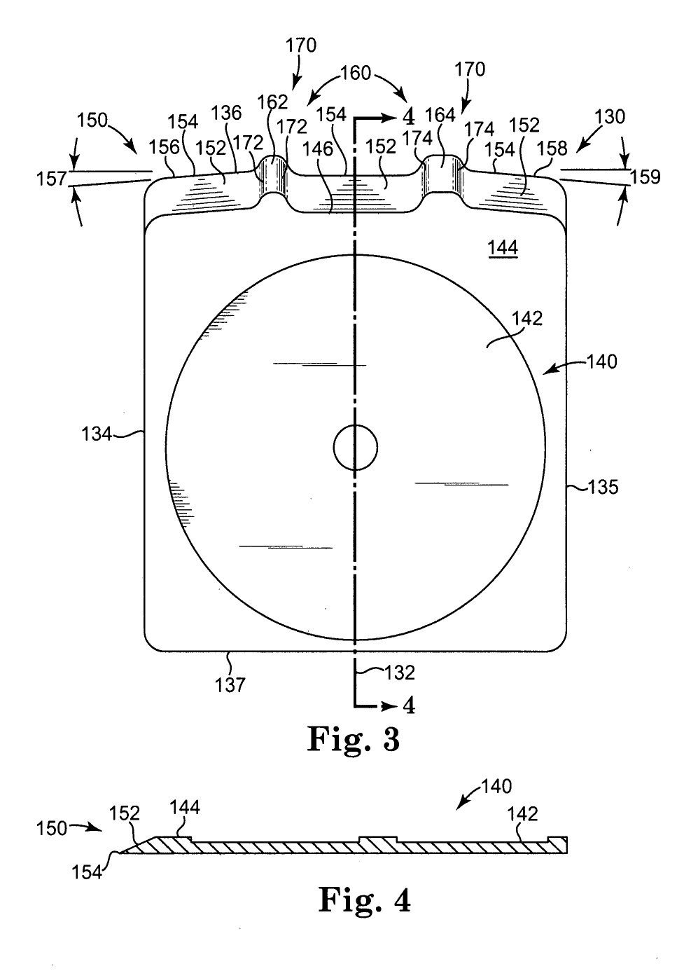

FIGS. 2-4 illustrate one embodiment of carrier 30. As one embodiment of carrier 30, carrier 130 includes a support portion 140, a tapered portion 150, and one or more insertion tabs 160. In one embodiment, tapered portion 150 is contiguous with support portion 140, and insertion tabs 160 protrude and extend beyond tapered portion 150, as described below.

In one embodiment, carrier 130 in generally rectangular in shape and includes a longitudinal axis 132. As such, carrier 130 includes opposite sides 134 and 135 oriented substantially parallel with longitudinal axis 132, and includes opposite ends 136 and 137 extended between opposite sides 134 and 135. In one embodiment, longitudinal axis 132 coincides with an axis of insertion of carrier 130 into printing device 20.

In one embodiment, support portion 140 of carrier 130 supports media 40 (FIG. 1) for printing on media 40 by printing device 20 (FIG. 1). As such, support portion 140 includes one of more features for supporting, holding, and/or retaining media 40 during positioning of carrier 130 in printing device 20 and/or during printing on media 40 by printing device 20. In one embodiment, for example, a recess 142 is formed in support portion 140 of carrier 130. As such, recess 142 is sized to receive media 40 and support media 40 during positioning of carrier 130 in printing device 20 and during printing on media 40 by printing device 20.

In one embodiment, recess 142 is circular in shape so as to accommodate media 40 as disk-shaped media. In one embodiment, a depth of recess 142 is substantially equal to a thickness of media 40 such that a surface of circular area 42 of media 40 and a surface 144 of support portion 140 form a substantially uniform or planar surface. Support portion 140 may also include additional features to accommodate and/or facilitate supporting of media 40 for printing on media 40.

In one embodiment, tapered portion 150 of carrier 130 is provided at an end 146 of support portion 140, and includes a surface 152 contiguous with surface 144 of support portion 140. As such, tapered portion 150 forms a leading portion of carrier 130 for insertion or positioning of carrier 130 in printing device 20 (FIG. 1).

In one embodiment, tapered portion 150 has a leading edge 154 and tapers from support portion 140 in a direction toward leading edge 154. As such, tapered portion 150 forms a ramp or wedge between leading edge 154 and surface 144 of support portion 140.

In one embodiment, leading edge 154 of tapered portion 150 is angled between insertion tabs 160 and sides 134 and 135 of carrier 130. More specifically, in one embodiment, a portion 156 of leading edge 154 extended between insertion tab 162 and side 134 of carrier 130 is oriented at an angle 157, and a portion 158 of leading edge 154 extended between insertion tab 164 and side 135 of carrier 130 is oriented at an angle 159. In one exemplary embodiment, an absolute value of angle 157 is substantially equal to an absolute value of angle 159.

In one embodiment, insertion tabs 160 of carrier 130 protrude from surface 152 of tapered portion 150, and extend beyond leading edge 154 of tapered portion 150. In addition, insertion tabs 160 follow the ramp or wedge shape of tapered portion 150. Accordingly, as described below, insertion tabs 160 become an initial point of contact for carrier 130 during insertion or positioning of carrier 130 in printing device 20 (FIG. 1).

In one embodiment, carrier 130 includes a pair of spaced insertion tabs 162 and 164. As such, insertion tabs 162 and 164 facilitate positioning of carrier 130 in printing device 20, as described below. In one embodiment, insertion tabs 162 and 164 are of differing widths such that insertion tab 162 is wider than insertion tab 164. Although insertion tab 162 is illustrated and described as being wider than insertion tab 164, insertion tab 164 may be wider than insertion tab 162. In addition, although illustrated and described as being of differing widths, insertion tabs 162 and 164 may be of the same width.

In one embodiment, ramps 170 are provided on both sides of insertion tabs 160. More specifically, ramps 172 are provided on opposite sides of insertion tab 162, and ramps 174 are provided on opposite sides of insertion tab 164. As such, ramps 170 extend between and provide a transition between insertion tabs 160 and surface 152 of tapered portion 150. Accordingly, as described below, ramps 170 assist during insertion or positioning of carrier 130 in printing device 20 (FIG. 1).

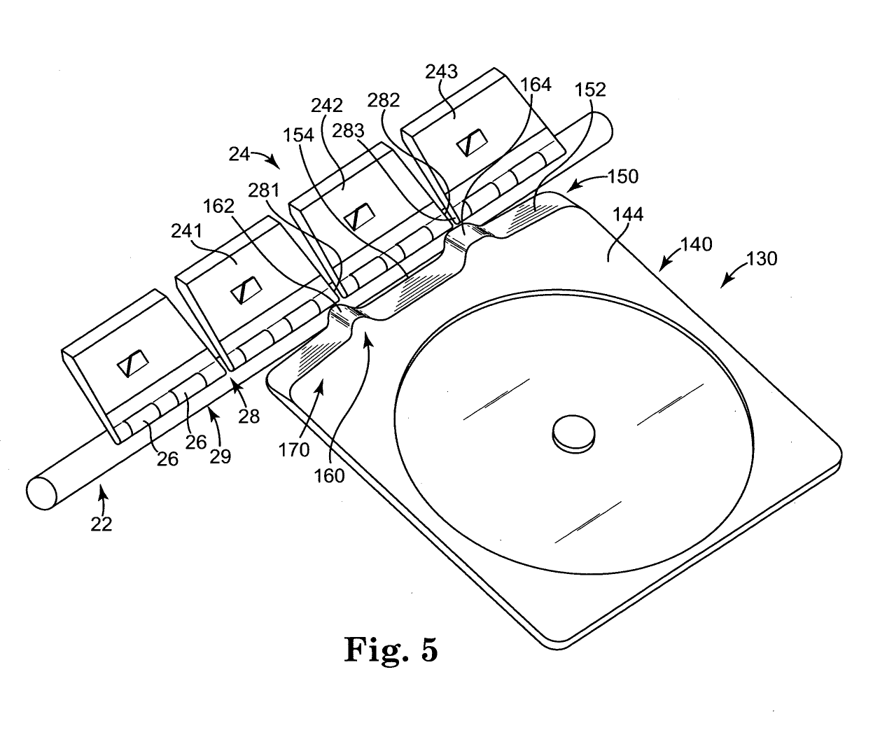

FIG. 5 illustrates one embodiment of a portion of printing device 20, and insertion or positioning of carrier 130 in printing device 20. In one embodiment, printing device 20 includes a feed roller 22 supported within printing device 20, and one or more media guides 24 supported within printing device 20. In one embodiment, media guides 24 are positioned next to each other along feed roller 22, and include pinch rollers 26 which contact and roll on feed roller 22.

Media guides 24 are positioned adjacent or opposed to feed roller 22 such that a nip 29 is formed between feed roller 22 and media guides 24, including, more specifically, between feed roller 22 and pinch rollers 26 of media guides 24. As such, media inserted into or positioned in nip 29 is fed into printing device 20 for printing thereon. Although four media guides 24 each including two pinch rollers 26 are illustrated, the number of media guides 24 and/or the number of pinch rollers 26 may vary.

In one embodiment, insertion tabs 160 are aligned with one or more media guides 24 when carrier 130 is inserted or positioned in printing device 20. More specifically, in one embodiment, each insertion tab 160 is aligned with a side 28 of one or more media guides 24. In one embodiment, for example, insertion tab 162 is aligned with side 281 of media guide 241, and insertion tab 164 is aligned with sides 282 and 283 of adjacent media guides 242 and 243.

In one embodiment, since insertion tabs 160 protrude from surface 152 of tapered portion 150 and extend beyond leading edge 154 of tapered portion 150, when carrier 130 is inserted or positioned in printing device 20, insertion tabs 160 contact media guides 24 before leading edge 154 of tapered portion 150 contacts media guides 24. Insertion tabs 160, therefore, contact media guides 24 before leading edge 154 contacts pinch rollers 26 and reaches nip 29. As such, insertion tabs 160 lift media guides 24, including, more specifically, sides 28 of media guides 24, as carrier 130 is inserted or positioned in printing device 20. Accordingly, after insertion tabs 160 are fed into nip 29, insertion tabs 160 lift one side of respective media guides 24 such that pinch rollers 26 of media guides 24 roll up tapered portion 150 and onto surface 144 of support portion 140.

In one embodiment, as insertion tabs 160 lift media guides 24, media guides 24 and, more specifically, pinch rollers 26 of media guides 24 follow tapered portion 150. In addition, ramps 170 provided on the sides of insertion tabs 160 assist in guiding media guides 24 up tapered portion 150 to support portion 140.

In one embodiment, as insertion tabs 160 lift media guides 24, carrier 130 is fed into printing device 20 by feed roller 22. As such, carrier 130 passes between feed roller 22 and pinch rollers 26 of media guides 24. In one embodiment, while and/or after a portion of carrier 130 passes between feed roller 22 and media guides 24, printing device 24 prints on media 40 (FIG. 1) as media 40 is supported by carrier 130.

With tapered portion 150 provided at a leading edge of carrier 130 and by including insertion tabs 160 at the leading edge, insertion tabs 160 serve as an initial surface to be captured in nip 29 as carrier 130 is fed between feed roller 22 and media guides 24. In addition, insertion tabs 160 also serve to lift media guides 24 and, more specifically, pinch rollers 26 of media guides 24, onto carrier 130, including, more specifically, support portion 140 of carrier 130, by wedging insertion tabs 160 and tapered portion 150 of carrier 130 under sides 28 of media guides 24. By wedging insertion tabs 160 under sides 28 of media guides 24, media guides 24 can be gradually lifted onto carrier 130. As such, carrier 130 can be fed into printing device 20 for printing on media 40 as supported by carrier 130.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A carrier for supporting a media in a printing device for printing thereon, the carrier comprising:
a support portion configured to support the media;
a tapered portion contiguous with the support portion; and
at least one tab protruding from a surface of the tapered portion and extending beyond a leading edge of the tapered portion.

2. The carrier of claim 1, wherein the tapered portion tapers in a direction from the support portion toward the leading edge of the tapered portion.

3. The carrier of claim 1, wherein the at least one tab extends from the leading edge of the tapered portion in a direction of insertion of the carrier into a printing device.

4. The carrier of claim 1, further comprising:
ramps provided on both sides of the at least one tab between the at least one tab and the surface of the tapered portion.

5. The carrier of claim 1, wherein the leading edge of the tapered portion is angled between the at least one tab and a side of the carrier.

6. The carrier of claim 1, wherein the at least one tab comprises a pair of spaced tabs each protruding from the surface of the tapered portion and extending beyond the leading edge of the tapered portion.

7. The carrier of claim 6, wherein the pair of spaced tabs are of differing widths.

8. The carrier of claim 1, further comprising:
a recess formed in the support portion, wherein the recess is sized to receive the media.

9. The carrier of claim 8, wherein a depth of the recess is substantially equal to a thickness of the media.

10. The carrier of claim 1, wherein the media comprises a disk-shaped media.

11. The carrier of claim 10, wherein the disk-shaped media comprises an optical data storage disk.

12. A system for printing on a media, the system comprising:
a printing device; and
a carrier for supporting the media in the printing device for printing thereon,
wherein the carrier includes a support portion, a tapered portion at one end of the support portion, and at least one tab protruding from a surface of the tapered portion and extending beyond a leading edge of the tapered portion,
wherein the tapered portion of the carrier is configured to be inserted into the printing device.

13. The system of claim 12, wherein the printing device includes a roller and at least one media guide opposed to the roller, wherein the roller and the at least one media guide form a nip therebetween, and wherein the tapered portion of the carrier is configured to be inserted into the nip between the roller and the at least one media guide.

14. The system of claim 13, wherein the at least one tab is configured to contact the at least one media guide before the leading edge of the tapered portion contacts the at least one media guide when the carrier is inserted into the printing device.

15. The system of claim 13, wherein the at least one tab is configured to be aligned with a side of the at least one media guide, and wherein the at least one tab is configured to lift the at least one media guide as the carrier is positioned in the printing device.

16. The system of claim 13, wherein the at least one media guide comprises a pair of media guides opposed to the roller, wherein the at least one tab is configured to be aligned with adjacent sides of the media guides, and wherein the at least one tab is configured to lift both of the media guides as the carrier is positioned in the printing device.

17. The system of claim 13, wherein the at least one tab comprises a pair of spaced tabs protruding from the surface of the tapered portion and extending beyond the leading edge of the tapered portion.

18. The system of claim 17, wherein the at least one media guide comprises a pair of media guides opposed to the roller, wherein each of the tabs is configured to be aligned with a side of one of the media guides, and wherein the tabs are configured to lift the media guides as the carrier is positioned in the printing device.

19. The system of claim 12, wherein the carrier further includes a recess formed in the support portion, wherein the recess is sized to receive the media.

20. The system of claim 12, wherein the media comprises a disk-shaped media.

21. A method of printing on a media, the method comprising:
supporting the media with a carrier; and
inserting the carrier into a printing device,
wherein the carrier includes a support portion, a tapered portion at one end of the support portion, and at least one tab protruding from a surface of the tapered portion and extending beyond a leading edge of the tapered portion,
wherein supporting the media includes supporting the media with the support portion of the carrier,
wherein inserting the carrier includes inserting the tapered portion of the carrier into the printing device.

22. The method of claim 21, wherein the printing device includes a roller and at least one media guide opposed to the roller, wherein the roller and the at least one media guide form a nip therebetween, and wherein inserting the carrier into the printing device includes inserting the tapered portion of the carrier into the nip between the roller and the at least one media guide.

23. The method of claim 22, wherein inserting the carrier into the printing device includes contacting the at least one media guide with the at least one tab before the leading edge of the tapered portion contacts the at least one media guide.

24. The method of claim 22, wherein inserting the carrier into the printing device includes aligning the at least one tab with a side of the at least one media guide and lifting the at least one media guide with the at least one tab.

25. The method of claim 22, wherein the at least one media guide of the printing device comprises a pair of media guides opposed to the roller, and wherein inserting the carrier into the printing device includes aligning the at least one tab of the carrier with adjacent sides of the media guides and lifting both of the media guides with the at least one tab.

26. The method of claim 22, wherein the at least one tab of the carrier comprises a pair of spaced tabs each protruding from the surface of the tapered portion and extending beyond the leading edge of the tapered portion.

27. The method of claim 26, wherein the at least one media guide of the printing device comprises a pair of media guides opposed to the roller, and wherein inserting the carrier into the printing device includes aligning each of the tabs with a side of one of the media guides and lifting the media guides with the tabs.

28. The method of claim 21, wherein supporting the media with the carrier includes supporting the media in a recess formed in the support portion of the carrier.

29. The method of claim 21, wherein the media comprises a disk-shaped media.
